(19) United States
(12) Patent Application Publication
(10) Pub. No.: US 2024/0211494 A1
(43) Pub. Date: Jun. 27, 2024

(54) INFORMATION PROCESSING METHOD AND INFORMATION PROCESSING APPARATUS

(71) Applicant: Fujitsu Limited, Kawasaki-shi (JP)

(72) Inventor: Yuji MIZOBUCHI, Kawasaki (JP)

(73) Assignee: Fujitsu Limited, Kawasaki-shi (JP)

(21) Appl. No.: 18/474,428

(22) Filed: Sep. 26, 2023

(30) Foreign Application Priority Data
Dec. 22, 2022 (JP) 2022-205050

(51) Int. Cl. G06F 16/28; G06F 16/22

(52) U.S. Cl. CPC G06F 16/285; G06F 16/2246

(57) ABSTRACT

A computer acquires a plurality of clustering results, each of which differs in the number of clusters, by performing clustering that classifies a plurality of sample programs into two or more clusters based on features associated with description and an execution performance of each sample program. The computer calculates, for each of the two or more clusters in each of the clustering results, a first evaluation value based on an index value for reusability of sample programs included in the cluster and the execution performances of the sample programs. The computer calculates, for each of the clustering results, a second evaluation value based on two or more of the first evaluation values corresponding to the two or more clusters. The computer selects, based on the second evaluation values corresponding to the clustering results, one clustering result amongst the multiple clustering results.

### CROSS-REFERENCE TO RELATED APPLICATION

This application is based upon and claims the benefit of priority of the prior Japanese Patent Application No. 2022-205050, filed on Dec. 22, 2022, the entire contents of which are incorporated herein by reference.

### FIELD

The embodiments discussed herein relate to an information processing method and information processing apparatus.

### BACKGROUND

Information processing apparatuses may store reusable programs as software components. Using the stored software components, software developers are able to perform programming efficiently. Software components may be created by collecting various existing programs as sample programs and analyzing the collected sample programs. The information processing apparatuses may assist in creating software components from such sample programs.

For example, there is a proposed component identification method of parsing source code containing multiple classes and identifying, as a component, a cluster of classes which is relatively independent of other classes. The proposed component identification method gives each class features that indicate presence or absence of calls to other classes, and defines inter-class distances based on the features. The component identification method performs hierarchical clustering in which multiple clusters each containing one or more classes are combined in stages based on the distances. Herewith, a tree diagram called dendrogram representing a tree-like hierarchical structure for the multiple classes is generated. See, for example, the following non-patent literature.

Jian Feng Cui and Heung Seok Chae, “Applying agglomerative hierarchical clustering algorithms to component identification for legacy systems”, Information and Software Technology, Volume 53, Issue 6, pages 601-614, June 2011.

### SUMMARY

According to one embodiment, there is provided a non-transitory computer-readable recording medium storing therein a computer program that causes a computer to execute a process including acquiring a plurality of clustering results, each of which differs in a number of clusters, by performing clustering that classifies a plurality of sample programs into two or more clusters based on features associated with description of each of the plurality of sample programs and an execution performance of each of the plurality of sample programs; calculating, for each cluster of the two or more clusters in each of the plurality of clustering results, a first evaluation value based on an index value for reusability of two or more sample programs included in the cluster and the execution performances of the two or more sample programs; calculating, for each of the plurality of clustering results, a second evaluation value based on two or more of the first evaluation values corresponding to the two or more clusters; and selecting, based on a plurality of second evaluation values respectively corresponding to the plurality of clustering results, one clustering result amongst the plurality of clustering results.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates a hardware example of an information processing apparatus of a second embodiment;

FIG. 3 illustrates an example of machine learning scripts and model accuracies;

FIG. 4 illustrates a division example of a machine learning script;

FIG. 5 illustrates an example of features of sample programs;

FIG. 6 illustrates an example of hierarchical clustering and cluster evaluation values;

FIG. 7 illustrates an example of distance correction using model accuracies;

FIG. 8 is a graph illustrating a relationship example between hierarchical tiers and hierarchical tier evaluation values;

FIG. 9 is a block diagram illustrating an example of functions of the information processing apparatus; and

FIG. 10 is a flowchart illustrating an example of a clustering procedure.

### DESCRIPTION OF EMBODIMENTS

Information processing apparatuses may produce, from a set of sample programs, multiple classification results each having a different number of clusters, like the clustering method described in the aforementioned literature (“Applying agglomerative hierarchical clustering algorithms to component identification for legacy systems”). One software component may be created from one cluster in a classification result.

However, a large number of sample programs collected may produce a large number of classification results each having a different number of clusters. For example, hierarchical clustering generates a dendrogram with deep hierarchical tiers. In this case, it may be a heavy burden to determine clusters of which classification result are suitable for software componentization.

Several embodiments will be described below with reference to the accompanying drawings.

### (a) First Embodiment

A first embodiment is described hereinafter.

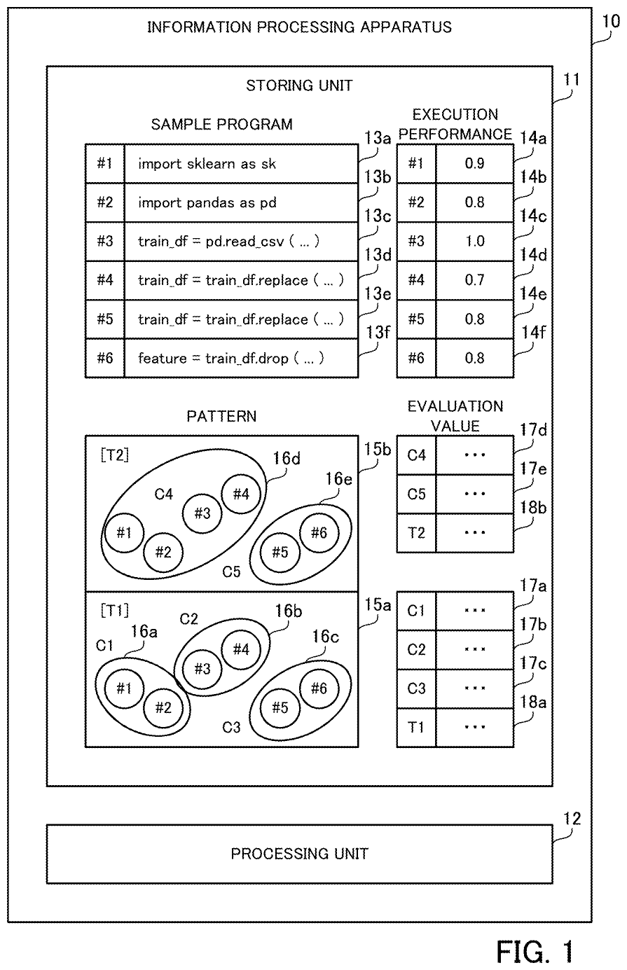

FIG. 1 illustrates an information processing apparatus according to the first embodiment.

An information processing apparatus 10 of the first embodiment supports creation of reusable software components from a set of sample programs. Software components may also be called code instances, code patterns, program components, code snippets, programming idioms, and the like. The information processing apparatus 10 may be a client device or server device. The information processing apparatus 10 may be called a computer, analysis device, or clustering device.

The information processing apparatus 10 includes a storing unit 11 and a processing unit 12. The storing unit 11 may be volatile semiconductor memory, such as random access memory (RAN), or a non-volatile storage device, such as a hard disk drive (HDD) or flash memory.

The processing unit 12 is, for example, a processor, such as a central processing unit (CPU), graphics processing unit (GPU), or digital signal processor (DSP). Note however that the processing unit 12 may include an electronic circuit, such as an application specific integrated circuit (ASIC) or field programmable gate array (FPGA). The processor executes programs stored in memory, such as RAM, (or stored in the storing unit 11). The term “multiprocessor”, or simply “processor”, may be used to refer to a set of multiple processors.

The storing unit 11 stores multiple sample programs and multiple execution performances corresponding one-to-one with the multiple sample programs. The multiple sample programs include, for example, sample programs 13a, 13b, 13c, 13d, 13e, and 13f. The multiple execution performances include, for example, execution performances 14a, 14b, 14c, 14d, 14e, and 14f.

Each sample program is part or the whole of an existing program. Such sample programs may be any of the following: source code; program modules, such as functions and classes; n continuous lines of source code (n=1, 2, 3, . . . ); and machine learning scripts for training a machine learning model.

Each execution performance may be measured by running the corresponding sample program. The execution performance may be measured by the information processing apparatus 10 or by a different information processing apparatus. If the sample program is a machine learning script, the execution performance is, for example, the prediction accuracy of a machine learning model trained by the machine learning script. In this case, the execution performance is indicated by a numerical value between 0 and 1, inclusive.

The processing unit 12 performs clustering, in which multiple sample programs are classified into two or more clusters, for multiple patterns each having a different number of clusters. The clustering runs a clustering algorithm, such as hierarchical clustering or k-means.

In the case of running hierarchical clustering, for example, the processing unit 12 first classifies multiple sample programs into different clusters. The processing unit 12 calculates inter-cluster distances (i.e., distances between clusters) in a given hierarchical tier, and integrates a pair of clusters with the smallest distance into one cluster in the hierarchical tier one tier above the given one. The processing unit 12 repeats integration of clusters until the number of clusters eventually becomes 1. Multiple hierarchical tiers generated by the hierarchical clustering correspond to the multiple patterns described above.

The multiple patterns include, for example, patterns 15a and 15b. For the pattern 15a, the processing unit 12 classifies the sample programs 13a, 13b, 13c, 13d, 13e, and 13f into clusters 16a, 16b, and 16c. The cluster 16a includes the sample programs 13a and 13b. The cluster 16b includes the sample programs 13c and 13d. The cluster 16c includes the sample programs 13e and 13f.

For the pattern 15b, the processing unit 12 classifies the sample programs 13a, 13b, 13c, 13d, 13e, and 13f into clusters 16d and 16e. The cluster 16d includes the sample programs 13a, 13b, 13c, and 13d. The cluster 16e includes the sample programs 13e and 13f. Based on the multiple patterns described above, the processing unit 12 acquires multiple clustering results, each with a different number of clusters, generated by clustering.

The clustering is performed based on features associated with the description of each of the multiple sample programs and the execution performances of the individual sample programs. The features may be calculated from character strings or words included in the sample program, or may be calculated in consideration of data handled by the sample program, such as the memory state during execution of the sample program. In principle, the processing unit 12 classifies sample programs with similar features into the same cluster, and classifies sample programs with distant features into different clusters. For example, the processing unit 12 defines the distances between sample programs based on the aforementioned features and performs clustering using the distances.

Note however that, according to the first embodiment, the processing unit 12 performs the clustering by means of execution performances in addition to the features. In the case where sample programs exhibit the same degree of similarity in the features, it is preferable that these sample programs tend to be classified into the same cluster if they both have high execution performances. On the other hand, if the sample programs differ in their execution performance, it is preferable that at least one of the sample programs, with a low execution performance, tend to be classified into a different cluster. For example, the processing unit 12 corrects the distance between two sample programs in terms of their features by using the execution performance of each of the two sample programs. The corrected distance may be inversely proportional to the execution performances. The processing unit 12 performs clustering based on the corrected distance.

For example, the processing unit 12 generates a feature vector for each of the sample programs 13a and 13b based on words included in the sample programs 13a and 13b. The processing unit 12 calculates the Euclidean distance between the two feature vectors. The processing unit 12 divides the cube of the Euclidean distance by the execution performances 14a and 14b to obtain the corrected distance. In clustering, the processing unit 12 uses the corrected distance to determine whether to classify the sample programs 13a and 13b into the same cluster.

Note that the processing unit 12 may be able to select a preferable pattern without performing clustering for all of multiple pattern candidates each having a different number of clusters, as described below. In that case, the processing unit 12 may skip clustering for some patterns amongst the multiple pattern candidates. The patterns to be skipped may be those with small numbers of clusters amongst the multiple pattern candidates. For example, the processing unit 12 may stop hierarchical clustering before the number of clusters reaches one.

The processing unit 12 calculates a first evaluation value for each of two or more clusters in each of the multiple patterns (clustering results). The first evaluation value may be called cluster evaluation value. For example, a cluster with a higher first evaluation value is more suitable to be made into a component.

In order to calculate the first evaluation value, the processing unit 12 uses a cohesion degree according to the variance of features of two or more sample programs included in each cluster. The cohesion degree increases as the variance of the features within the cluster decreases. The cohesion degree may increase as the distances to other clusters increase. The Calinski-Harabasz index or the Davies-Bouldin index may be used as an index of the cohesion degree. For example, the higher the cohesion degree, the higher the first evaluation value.

To calculate the first evaluation value, the processing unit 12 may further use the number of sample programs included in the cluster. The number of sample programs may be called cluster size. For example, the larger the cluster size, the higher the first evaluation value. The cluster size and the cohesion degree may be interpreted as index values for reusability of the sample programs.

In addition, in calculating the first evaluation value, the processing unit 12 further uses the execution performances of the two or more sample programs included in the cluster. For example, the processing unit 12 uses the mean and variance of the execution performances associated with the cluster to calculate the first evaluation value. For example, the higher the mean of the execution performances, the higher the first evaluation value, and the smaller the variance of the execution performances, the higher the first evaluation value.

The processing unit 12 calculates a second evaluation value for each of the multiple patterns (clustering results) based on two or more first evaluation values corresponding to two or more clusters included in the pattern. The second evaluation value may be called a pattern evaluation value or a hierarchical tier evaluation value. For example, the processing unit 12 calculates the sum of two or more first evaluation values as the second evaluation value.

For example, the processing unit 12 calculates, for the pattern 15a, evaluation values 17a, 17b, and 17c of the clusters 16a, 16b, and 16c, and combines the evaluation values 17a, 17b, and 17c to calculate an evaluation value 18a of the pattern 15a. In addition, for the pattern 15b, the processing unit 12 calculates evaluation value 17d and 17e of the clusters 16d and 16e and combines the evaluation values 17d and 17e to calculate an evaluation value 18b of the pattern 15b.

The processing unit 12 selects the clustering result of a pattern suitable for componentization based on multiple second evaluation values corresponding to the multiple patterns (clustering results). For example, the processing unit 12 selects the clustering result of one hierarchical tier from a tree structure generated by hierarchical clustering. The processing unit 12 may compare the second evaluation values among the multiple patterns and select a pattern with the highest second evaluation value. For example, if the evaluation value 18b is higher than the evaluation value 18a, the clustering result of the pattern 15b may be selected. In this case, one software component may be created from each of the clusters 16d and 16e.

The processing unit 12 outputs the clustering result of the selected pattern. The processing unit 12 may store the clustering result in a non-volatile storage device; display it on a display device; and/or transmit it to a different information processing apparatus. The processing unit 12 may also prompt the user to create software components from clusters included in the selected pattern. The user may extract a common program description from two or more sample programs included in each cluster, and may create a software component that represents the extracted program description.

In addition, the processing unit 12 may present one sample program or a small number of sample programs included in each cluster to the user as software component candidates. The sample programs to be presented may be central sample programs which have features close to the mean features of the cluster. In addition, the processing unit 12 may rank the two or more sample programs included in the cluster according to some criteria and present the ranking information to the user.

Reference to the execution performances in the clustering allows the aforementioned second evaluation values to have a constant variation trend with respect to the number of clusters. For example, when the second evaluation values are arranged in descending order of the number of clusters, the second evaluation values may increase while the number of clusters is large and then start decreasing when the number of clusters becomes sufficiently small. Therefore, in the relationship between the number of clusters and the second evaluation values, there is a peak in the second evaluation values.

In view of the above, the processing unit 12 need not calculate the second evaluation value for all of the multiple pattern candidates for which clustering may be performed, and may skip calculation of the second evaluation value for some patterns. For example, the processing unit 12 calculates the second evaluation values in descending order of the number of clusters and detects a peak in the second evaluation values. Once the peak is detected, the processing unit 12 may skip the calculation of the second evaluation value for clustering results with fewer numbers of clusters than the number of clusters corresponding to the peak.

The peak is, for example, a change point at which the variation in the second evaluation values turns from increase to decrease when the second evaluation values are calculated in descending order of the number of clusters. For example, in the case of calculating the second evaluation values in descending order of the number of clusters, the processing unit 12 may detect the peak in the second evaluation values when the current second evaluation value becomes smaller than the second evaluation value calculated immediately before by a predetermined reference or more. Note that specific technique and reference for detecting the peak in the second evaluation values are not limited to the above-described examples, and different technique and reference, including the technique described below, may be employed instead.

For example, the processing unit 12 calculates the second evaluation values preferentially from lower hierarchical tiers in the tree structure generated by hierarchical clustering, and skips calculation of the second evaluation value for upper hierarchical tiers. In other words, when the clustering results are aligned in descending order of the number of clusters, the processing unit 12 skips calculation of the second evaluation value for clustering results that appear after the peak. Note that the above description explains the case in which the second evaluation values are arranged in descending order of the number of clusters; however, the processing unit 12 is also able to calculate the peak in the second evaluation values when the second evaluation values are arranged in ascending order of the number of clusters.

As described above, the information processing apparatus 10 of the first embodiment performs clustering, in which multiple sample programs are classified into two or more clusters, for multiple patterns each having a different number of clusters. Here, the clustering is performed based on features associated with the descriptions of the individual sample programs and their execution performances. The information processing apparatus 10 calculates a first evaluation value for each of two or more clusters included in each pattern, based on a cohesion degree according to the variance of features of the sample programs and their execution performances. The information processing apparatus 10 calculates, for each pattern, a second evaluation value based on two or more first evaluation values corresponding to the two or more clusters. The information processing apparatus 10 selects, based on the multiple second evaluation values corresponding to the multiple patterns, the clustering result of a pattern.

Herewith, the clustering result including clusters suitable for creating software components is identified amongst multiple clustering results with different numbers of clusters. For example, a hierarchical tier including suitable clusters is identified amongst the results of hierarchical clustering. Therefore, even when a large number of sample programs is collected, it is possible to streamline the creation of software components.

Among the information used to calculate the first evaluation value, the cohesion degree relates to reusability indicating that similar sample programs appear with high frequency. In addition, the execution performance relates to the utility of the software component in contributing to software quality improvement. Hence, software components created from clusters with high first evaluation values are expected to have high reusability and utility and, therefore, improved quality.

Further, the information processing apparatus 10 performs the clustering in consideration of execution performances of the sample programs in addition to the features associated with the descriptions of the sample programs. This prevents the second evaluation values from randomly fluctuating for the number of clusters so that they exhibit a constant variation trend. Therefore, the information processing apparatus 10 is able to select a suitable pattern without calculating the second evaluation value for all patterns of the number of clusters. In this manner, the load on the information processing apparatus 10 is reduced.

In the clustering, the information processing apparatus 10 may correct distances of features using execution performances and classify sample programs based on the corrected distances. The corrected distances may be inversely proportional to the execution performances. This facilitates sample programs with high execution performances to be preferentially grouped into the same cluster. As a result, the second evaluation values have a peak for the numbers of clusters, and the information processing apparatus 10 is able to efficiently search for a pattern with the highest second evaluation value.

In addition, based on the relationship between the number of clusters and the second evaluation values, the information processing apparatus 10 may skip calculating the second evaluation value for patterns other than those for which the second evaluation values have already been calculated amongst multiple pattern candidates. This reduces the load on the information processing apparatus 10. Further, the information processing apparatus 10 may calculate the second evaluation values in descending order of the number of clusters, and may skip calculation of the second evaluation value for other patterns according to the detection of the peak in the second evaluation values. This streamlines the search for the best pattern.

The clustering may be hierarchical clustering that generates a tree structure including multiple hierarchical tiers, and the information processing apparatus 10 may select a hierarchical tier from the tree structure. This allows for selection of clusters with suitable granularity for creating software components. The first evaluation value may be calculated based on the number of sample programs, the cohesion degree, and the mean and the variance of the execution performances. Herewith, clusters are evaluated from the view point of reusability and utility of software components, which improves the qualities of the software components.

### (b) Second Embodiment

A second embodiment is described next.

An information processing apparatus 100 of the second embodiment collects and analyzes existing machine learning scripts, and supports creation of reusable and useful software components. The information processing apparatus 100 may be a client device or a server device. The information processing apparatus 100 may be called a computer, analysis device, or clustering device. The information processing apparatus 100 corresponds to the information processing apparatus 10 of the first embodiment.

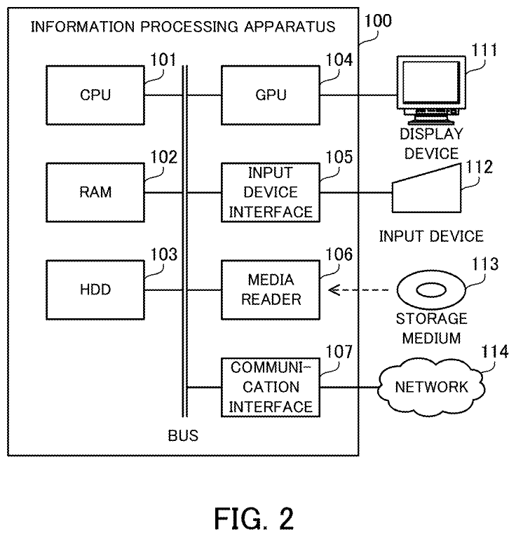

FIG. 2 illustrates a hardware example of the information processing apparatus of the second embodiment.

The information processing apparatus 100 includes a CPU 101, a RAM 102, an HDD 103, a GPU 104, an input device interface 105, a media reader 106, and a communication interface 107, which are all connected to a bus. The CPU 101 corresponds to the processing unit 12 of the first embodiment. The RAM 102 or the HDD 103 corresponds to the storing unit 11 of the first embodiment.

The CPU 101 is a processor configured to execute program instructions. The CPU 101 reads out programs and data stored in the HDD 103, loads them into the RAM 102, and executes the loaded programs. Note that the information processing apparatus 100 may include two or more processors.

The RAM 102 is volatile semiconductor memory for temporarily storing therein programs to be executed by the CPU 101 and data to be used by the CPU 101 for its computation. The information processing apparatus 100 may be provided with a different type of volatile memory other than RAM.

The HDD 103 is a non-volatile storage device to store therein software programs, such as an operating system (OS), middleware, and application software, as well as various types of data. The information processing apparatus 100 may be provided with a different type of non-volatile storage device, such as flash memory or a solid state drive (SSD).

The GPU 104 performs image processing in cooperation with the CPU 101, and displays video images on a screen of a display device 111 coupled to the information processing apparatus 100. The display device 111 may be a cathode ray tube (CRT) display, a liquid crystal display (LCD), an organic electro-luminescence (OEL) display, or a projector. An output device, such as a printer, other than the display device 111 may be connected to the information processing apparatus 100. In addition, the GPU 104 may be used as a general-purpose computing on graphics processing unit (GPGPU). The GPU 104 may execute a program according to an instruction from the CPU 101. The information processing apparatus 100 may have volatile semiconductor memory other than the RAM 102 as GPU memory.

The input device interface 105 receives an input signal from an input device 112 connected to the information processing apparatus 100. Various types of input devices may be used as the input device 112, for example, a mouse, a touch panel, or a keyboard. Multiple types of input devices may be connected to the information processing apparatus 100.

The media reader 106 is a device for reading programs and data recorded on a storage medium 113. The storage medium 113 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 106 copies the programs and data read out from the storage medium 113 to a different storage medium, for example, the RAM 102 or the HDD 103. The read programs may be executed by the CPU 101.

The storage medium 113 may be a portable storage medium and be used to distribute the programs and data. In addition, the storage medium 113 and the HDD 103 may be referred to as computer-readable storage media.

The communication interface 107 communicates with different information processing apparatuses via a network 114. The communication interface 107 may be a wired communication interface connected to a wired communication device, such as a switch or router, or may be a wireless communication interface connected to a wireless communication device, such as a base station or access point.

Next described are clusters of sample programs to be analyzed.

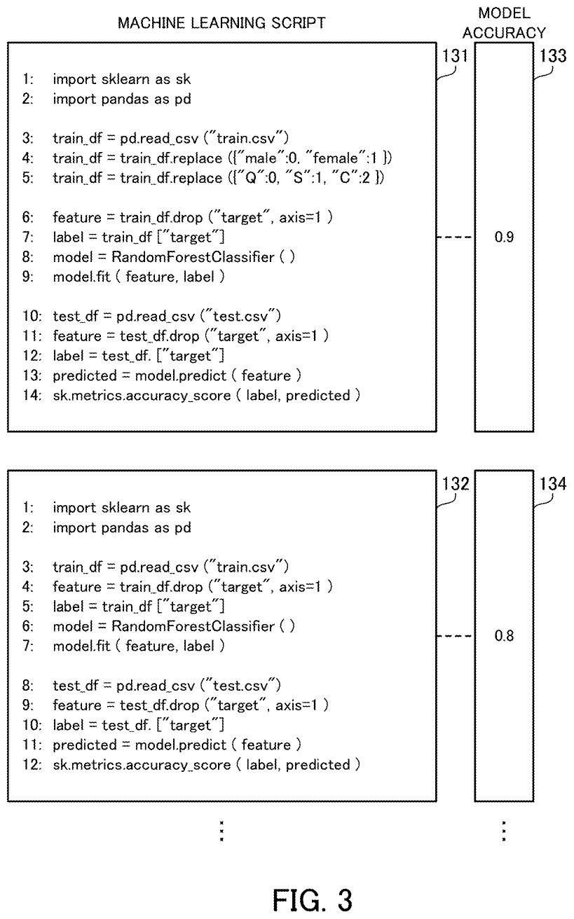

FIG. 3 illustrates an example of machine learning scripts and model accuracies.

The information processing apparatus 100 stores multiple machine learning scripts, including machine learning scripts 131 and 132. The machine learning scripts are source code that defines procedures of machine learning. The machine learning involves training a machine learning model using training data and measuring the model accuracy of the machine learning model using test data.

The machine learning scripts may use machine learning libraries including classes and methods. The machine learning model is, for example, a random forest, support vector machine, neural network, or the like. Accuracy (correct answer rate), for example, is used as a metric of the model accuracy. The accuracy takes a numerical value between 0 and 1, inclusive, and the higher the accuracy, the better the machine learning model.

The training data and the test data are, for example, tabular data, such as comma-separated values (CSV). The tabular data includes multiple columns and multiple records. Some of the columns are used for explanatory variables while a different column is used for an objective variable. The values of the explanatory variables are input data that enters the machine learning model. The values of the objective variable are labels that indicate correct answers to outputs of the machine learning model. The machine learning scripts may perform preprocessing on the tabular data. The preprocessing includes, for example, normalization for converting the values of specific columns in the tabular data into numerical values within a certain range.

The machine learning script 131 contains 14 lines of code without blank lines. The code may also be called instructions or statements. The machine learning script 131 preprocesses a training data table, then designates, in the training data table, columns representing explanatory variables and a column representing an objective variable, and trains a random forest as a machine learning model. The machine learning script 131 designates, in a test data table, columns representing the explanatory variables and a column representing the objective variable, calculates a predicted value by inputting the values of the explanatory variables to the random forest, and compares the predicted value with a label to calculate the accuracy as the model accuracy.

The machine learning script 132 includes 12 lines of code without blank lines. The machine learning script 132 does not include preprocessing code corresponding to the fourth and fifth lines of the machine learning script 131. The machine learning script 132 is otherwise the same as the machine learning script 131.

The information processing apparatus 100 stores therein training data and test data used in each machine learning script, in association with the machine learning script. The information processing apparatus 100 executes the machine learning script using the stored training data and test data to measure the model accuracy of a machine learning model trained in the machine learning script. The information processing apparatus 100 stores the obtained model accuracy in association with the machine learning script. Note however that the model accuracy may be measured by a different information processing apparatus.

For example, the information processing apparatus 100 executes the machine learning script 131 to measure a model accuracy 133. The information processing apparatus 100 also executes the machine learning script 132 to measure a model accuracy 134. Note that the information processing apparatus 100 may define features of each sample program based on memory states at the time of execution, as will be described later. In this case, the information processing apparatus 100 stores, as an execution history, a memory image for each step (e.g., for each line) when executing a machine learning script.

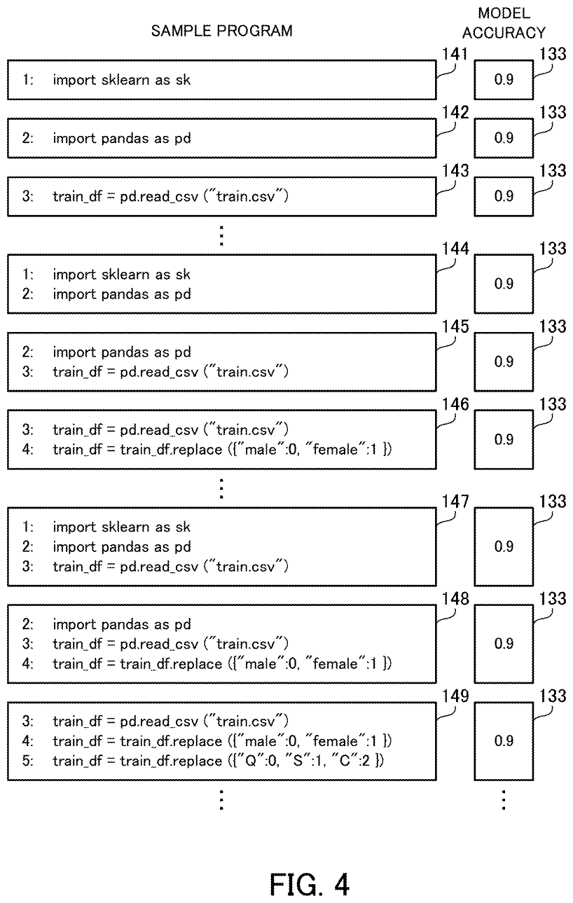

FIG. 4 illustrates a division example of a machine learning script.

The information processing apparatus 100 divides each of multiple machine learning scripts to extract multiple sample programs which are candidates for reusable software components. The machine learning scripts are often poorly structured, unlike large business system programs. Therefore, it is difficult for the information processing apparatus 100 to identify, from the machine learning scripts, program units, such as classes and functions, that represent functional blocks. In view of this, the information processing apparatus 100 exhaustively extracts n consecutive lines (n=1, 2, 3, and so forth) of code included in each machine learning script as sample programs.

For example, the information processing apparatus 100 extracts, from the machine learning script 131, a sample program 141 representing the code on the first line, a sample program 142 representing the code on the second line, and a sample program 143 representing the code on the third line 143. Thus, the information processing apparatus 100 extracts 14 sample programs, each representing one line of code.

The information processing apparatus 100 also extracts a sample program 144 representing the code on the first and second lines, a sample program 145 representing the code on the second and third lines, and a sample program 146 representing the code on the third and fourth lines. Thus, the information processing apparatus 100 extracts 13 sample programs each representing two consecutive lines of code. Further, the information processing apparatus 100 extracts a sample program 147 representing the code on the first to third lines, a sample program 148 representing the code on the second to fourth lines, and a sample program 149 representing the code on the third to fifth lines. Thus, the information processing apparatus 100 extracts 12 sample programs each representing three consecutive lines of code.

The number of lines that is included in one sample program may have a predetermined upper limit, but such an upper limit is optional. The information processing apparatus 100 extracts multiple sample programs also from the machine learning script 132, as with the machine learning script 131. The information processing apparatus 100 assigns the model accuracy measured for the original machine learning script to each extracted sample program. For example, the information processing apparatus 100 assigns the model accuracy 133 of the machine learning script 131 to each of the sample programs 141 to 149.

Note that when a reference machine learning script exists, the information processing apparatus 100 may extract a difference between the reference machine learning script and another machine learning script as a sample. For example, if the machine learning script 132 is used as a reference, the information processing apparatus 100 extracts the code on the fourth and fifth lines from the machine learning script 131 as a sample program. Extraction of the difference facilitates identification of codes that contribute to improved model accuracy.

In this case, the information processing apparatus 100 may assign, to the sample program made of the extracted difference, a relative model accuracy indicating the difference from the model accuracy of the reference machine learning script. The relative model accuracy may be a negative number. For example, the information processing apparatus 100 assigns a relative model accuracy of +0.1 to the fourth and fifth lines of the machine learning script 131.

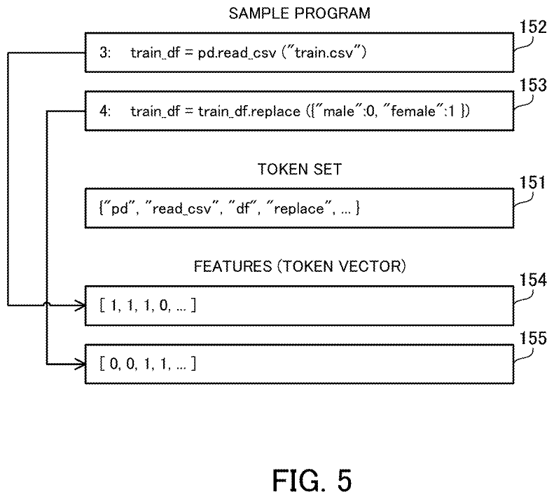

FIG. 5 illustrates an example of features of sample programs.

The information processing apparatus 100 calculates features of each sample program in order to define the “distance” which indicates the degree of similarity between sample programs. The features are expressed as a vector enumerating two or more numerical values corresponding to two or more dimensions. The following description of the second embodiment assumes the case where the features are calculated from a character string itself included in each sample program. Note however that the information processing apparatus 100 may calculate the features by other methods, as will be described below.

The information processing apparatus 100 extracts one or more tokens from each of multiple sample programs. Each token is a character string that has meaning in a programming language, such as a variable name or function name, and may be called a word. The information processing apparatus 100 detects delimiters, such as spaces, dots, and commas, and divides each sample program into tokens.

Note however that, user-defined variable names are less important in determining the degree of similarity between sample programs. This is because two sample programs may perform substantially the same data processing even if the user-defined variable names are different. Therefore, the information processing apparatus 100 may extract, as tokens, only known names, such as library names, class names of classes included in the libraries, and method names of methods included in the libraries.

The information processing apparatus 100 generates a token set 151 which enumerates tokens appearing one or more times in multiple sample programs. The information processing apparatus 100 refers to the token set 151 to calculate one set of features for each sample program. The set of features may be referred to as a token vector and has the same number of dimensions as the token set 151. A dimension value corresponding to a token appearing one or more times in the sample program is “1”, and a dimension value corresponding to a token not appearing even once in the sample program is “0”.

For example, the first dimension of the token set 151 indicates a token “pd”; the second dimension indicates a token “read_csv”; the third dimension indicates a token “df”; and the fourth dimension indicates a token “replace”. The information processing apparatus 100 calculates a set of features 154 from a sample program 152 and a set of features 155 from a sample program 153.

The sample program 152 includes the tokens “pd”, “read_csv”, and “df” but does not include the token “replace”. Therefore, the values of the first to third dimensions of the features 154 are “1” while the value of the fourth dimension of the features 154 is “0”. The sample program 153 does not include the tokens “pd” and “read_csv” but includes the tokens “df” and “replace”. Therefore, the values of the first and second dimensions of the features 155 are “0” while the values of the third and fourth dimensions of the features 155 are “1”.

Note that the information processing apparatus 100 may calculate features from execution histories of a machine learning script. For example, the information processing apparatus 100 extracts, from a memory image saved at the start or end point of each sample program, tabular data at that point. The information processing apparatus 100 may calculate, as the features, statistics, such as the average value, maximum value, and minimum value of each column included in the tabular data. When tabular data with different structures are used depending on sample programs, or when preprocessing is performed on the tabular data, statistics of the tabular data may be useful features representing characteristics of the sample program.

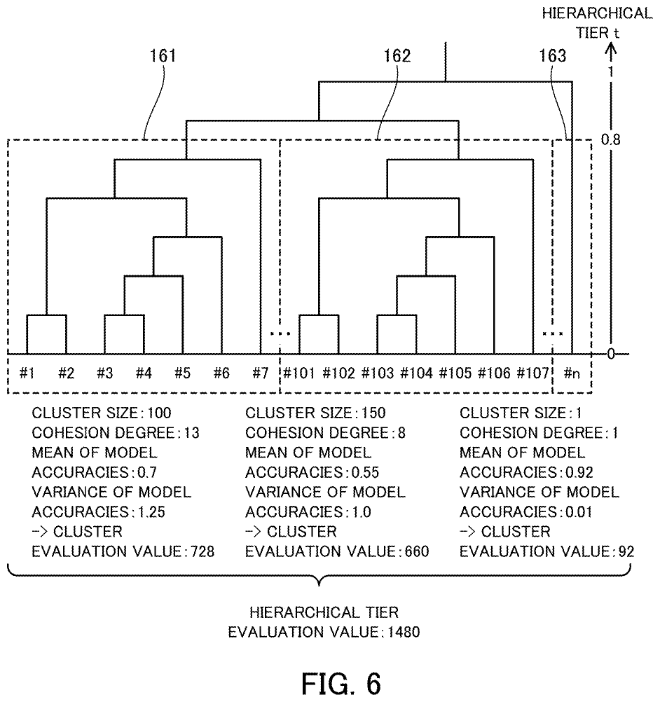

FIG. 6 illustrates an example of hierarchical clustering and cluster evaluation values.

The information processing apparatus 100 performs hierarchical clustering on the multiple sample programs extracted above using the features calculated in the aforementioned manner. In the hierarchical clustering, the information processing apparatus 100 first generates the same number of clusters as the sample programs, and classifies each of the multiple sample programs into a different cluster. The information processing apparatus 100 calculates the distance between clusters (inter-cluster distance) based on the features of sample programs individually included in the clusters, and integrates a pair of clusters with the smallest inter-cluster distance into a single cluster. The information processing apparatus 100 repeats the calculation of the inter-cluster distance and the integration of paired clusters until the number of clusters becomes one.

For the distance between two sample programs, the Euclidean distance between two sets of features is used. The inter-cluster distance is, for example, the minimum or maximum distance amongst distances between sample programs included in different clusters. The method using the minimum distance is sometimes called the shortest distance method, and the method using the maximum distance is sometimes called the longest distance method. Alternatively, the average distance between sample programs included in different clusters may be used instead.

Herewith, a dendrogram as illustrated in FIG. 6 is generated. The dendrogram includes a root node representing one cluster containing all sample programs and leaf nodes representing multiple sample programs each included in a different cluster. In the dendrogram, a hierarchical tier t is defined, which indicates the stage of hierarchical clustering progression. The hierarchical tier of the leaf nodes has t=0, and the hierarchical tier of the root node has t=1. The hierarchical tier t takes a numerical value between 0 and 1, inclusive.

When one hierarchical tier is selected from the dendrogram, one or more clusters residing in the selected hierarchical tier are identified. A hierarchical tier other than t=0 and t=1 is usually selected. The user creates one software component from each of the identified clusters. Two or more sample programs included in the same cluster are expected to have common features. Therefore, for example, the user creates a software component by extracting common feature code from the two or more sample programs and rewriting it into a reusable format.

For example, in a hierarchical tier of t=0.8, multiple sample programs are classified into clusters 161, 162, and 163. The user creates one software component from the cluster 161. The user also creates one software component from the cluster 162. Further, the user creates one software component from the cluster 163. Note that the software components are reusable programs and may also be referred to as code instances, code patterns, program components, code snippets, or programming idioms.

However, due to the nature of machine learning scripts described above, a large number of sample programs to be candidates for software components is extracted from the machine learning scripts. Hierarchical clustering performed on a large number of sample programs produces a dendrogram with deep hierarchical tiers. For this reason, it may be difficult for the user to select a hierarchical tier suitable for software componentization from the dendrogram. In view of this problem, the information processing apparatus 100 calculates, for each of the multiple hierarchical tiers, a hierarchical tier evaluation value indicating whether the hierarchical tier is suitable for software componentization, and selects an appropriate hierarchical tier based on the hierarchical tier evaluation values.

A hierarchical tier evaluation value Pₜ of the hierarchical tier t is given by Equation (1) below. The hierarchical tier evaluation value Pₜ is the sum of cluster evaluation values P_{t, i} calculated for clusters C_{t, i} (i=1, 2, 3, and so on) residing in the hierarchical tier t. Each cluster evaluation value P_{t, i} is the product of the first to fourth terms below.

$${P}_{t} = {\sum }_{i} {P}_{t , i} = {\sum }_{i} ( \vert {C}_{t , i} \vert * \frac{1}{{D}_{t , i}} ) * ( \frac{Σ {u}_{t , i}}{\vert {C}_{t , i} \vert} * \frac{\vert {C}_{t , i} \vert}{{Σ ( {u}_{t , i} - {\overline{u}}_{t , i} )}^{2} + β} ) \qquad ( 1 )$$

The first term is the cluster size which indicates the number of sample programs included in the cluster. In Equation (1), |C_{t, i}| represents the cluster size of the cluster C_{t, i}. The cluster size relates to reusability of a software component to be created. Frequent occurrence of similar code indicates high reusability of the software component. Therefore, the larger the cluster size, the larger the cluster evaluation value P_{t, i}.

The second term is the cohesion degree of two or more sample programs included in the cluster. In Equation (1), 1/D_{t, i} represents the cohesion degree of the cluster C_{t, i}. The smaller the distance between sample programs in the cluster, the higher the degree of cohesion of the cluster. In addition, the greater the distance from sample programs belonging to other clusters, the higher the degree of cohesion. Features used for the calculation of the cohesion degree and those used for the hierarchical clustering may be the same or different. The cohesion degree relates to reusability of a software component to be created. A cluster with a high cohesion degree represents features of unique code different from those of other clusters. Therefore, the cluster evaluation value P_{t, i} increases as the cohesion degree increases.

For the cohesion degree, for example, the Calinski-Harabasz index or the Davies-Bouldin index is used. The Calinski-Harabasz index is inversely proportional to the variance of intra-cluster features and proportional to the variance of inter-cluster features. The variance of inter-cluster features is the variance of the distance between the center of the features of all the sample programs and the center of the features of each of the multiple clusters. The center of the features is, for example, the average value of the features.

The Davies-Bouldin index is obtained by dividing the sum of the variance of intra-cluster features of a first cluster and the variance of intra-cluster features of a second cluster, which most closely resembles the first cluster, by the inter-cluster distance. The second cluster is a cluster with the smallest inter-cluster distance from the first cluster. The inter-cluster distance is the distance between the center of the features of the first cluster and the center of the features of the second cluster.

Note that the cohesion degree may be calculated for each cluster, or may be calculated commonly for all the multiple clusters in the same hierarchical tier. The Calinski-Harabasz index common to all the clusters is calculated using the average value of the intra-cluster variances of the multiple clusters. The Davies-Bouldin index common to all the clusters is the average value of the Davies-Bouldin indices of the individual clusters.

The Calinski-Harabasz index is described in the following non-patent literature: T. Calinski and J. Harabasz, “A Dendrite Method for Cluster Analysis”, Communications in Statistics, Volume 3, Issue 1, pages 1-27, January 1974. The Davies-Bouldin index is described in the following non-patent literature: David Davies and Donald Bouldin, “A Cluster Separation Measure”, IEEE Transactions on Pattern Analysis and Machine Intelligence, Volume 1, Issue 2, pages 224-227, April 1979.

The third term is the mean of the model accuracies of the sample programs included in the cluster. In Equation (1), u_{t, i} represents the model accuracies of the sample programs included in the cluster C_{t, i}. The mean of the model accuracies relates to the utility of the software component to be created. High model accuracy of a machine learning model trained using the software component indicates high utility of the software component. Therefore, the higher the mean of the model accuracies, the larger the cluster evaluation value P_{t, i}.

The fourth term is the reciprocal of the variance of the model accuracies of the sample programs included in the cluster. In Equation (1), β is a very small constant used to avoid zero variance and, for example, β=0.01. The reciprocal of the variance of the model accuracies relates to the utility of the software component to be created. Inconsistent model accuracy of a machine learning model trained with the software component indicates that the software component is not sufficiently fragmented. Therefore, the cluster evaluation value P_{t, i} increases as the variance of the model accuracies decreases.

For example, for the aforementioned cluster 161, the following are obtained: the cluster size is 100; the cohesion degree is 13; the mean of the model accuracies is 0.7; and the variance of the model accuracies is 1.25. In this case, the cluster evaluation value of the cluster 161 is 728. For the cluster 162, the followings are obtained: the cluster size is 150; the cohesion degree is 8; the mean of the model accuracies is 0.55; and the variance of the model accuracies is 1.0. In this case, the cluster evaluation value of the cluster 162 is 660. For the cluster 163, the followings are obtained: the cluster size is 1; the cohesion degree is 1; the mean of the model accuracies is 0.92; and the variance of the model accuracies is 0.01. In this case, the cluster evaluation value of the cluster 163 is 92. As a result, the hierarchical tier evaluation value of the hierarchical tier with t=0.8 is 1480.

The information processing apparatus 100 selects a hierarchical tier with the highest hierarchical tier evaluation value amongst the multiple hierarchical tiers. However, in general, there is no correlation between the features of sample programs (the features associated with descriptions of the programs) and their model accuracies. Therefore, if hierarchical clustering is performed based solely on the Euclidean distances of the features, sample programs with high model accuracies would be dispersed into various clusters.

As a result, the hierarchical tier evaluation values randomly fluctuate as the hierarchical tier t increases. Accordingly, the information processing apparatus 100 needs to calculate the hierarchical tier evaluation value for all hierarchical tiers in order to identify the hierarchical tier with the highest hierarchical tier evaluation value. When the number of sample programs is N, the amount of calculation for calculating the hierarchical tier evaluation value for all hierarchical tiers is on the order of log(N).

In view of the above, according to the second embodiment, the information processing apparatus 100 corrects each distance used in the hierarchical clustering by using model accuracies, as defined by Equation (2) below. In Equation (2), d₀(cᵢ, cⱼ) is the Euclidean distance between sample programs cᵢ and cⱼ in terms of their features. u_{ci} and u_{cj} are model accuracies of the sample programs cᵢ and cⱼ. dᵣ(cᵢ, cⱼ) is the corrected distance between the sample programs cᵢ and cⱼ.

$${d}_{r} ( {c}_{i} , {c}_{j} ) = \frac{{d}_{0} ( {c}_{i} , {c}_{j} )}{\frac{{u}_{ci} * {u}_{cj}}{{d}_{0}^{2} ( {c}_{i} , {c}_{j} )}} = \frac{{d}_{0}^{3} ( {c}_{i} , {c}_{j} )}{{u}_{ci} * {u}_{cj}} \qquad ( 2 )$$

As defined by Equation (2), the corrected distance is proportional to the cube of the Euclidean distance before correction and inversely proportional to the product of the model accuracies of the two sample programs. dᵣ(cᵢ, cⱼ) in Equation (2) is defined with reference to the universal gravitational equation. The universal gravitational equation states that the universal gravitation is proportional to the product of the masses of two bodies and inversely proportional to the square of the distance between them. Here, dᵣ(cᵢ, cᵢ) is calculated by dividing the Euclidean distance of the features by gravity corresponding to the model accuracies.

When hierarchical clustering is performed using each corrected distance given by Equation (2), the distance between two sample programs with high model accuracies appears to be small, and even in lower hierarchical tiers, they tend to be classified into the same cluster. In lower hierarchical tiers, sample programs both having high model accuracies, with a small Euclidean distance of the features, are preferentially integrated into the same cluster. As the hierarchical tier t increases, clusters grow around such sample programs. On the other hand, in higher hierarchical tiers, sample programs with large Euclidean distances of the features may join the same cluster, and thus sample programs with low model accuracies may be included in the cluster.

Therefore, when hierarchical clustering is performed using the corrected distances described above, the hierarchical tier evaluation values exhibit a constant variation trend as the hierarchical tier t increases. In lower hierarchical tiers, the hierarchical tier evaluation values generally increase monotonically with an increase in the hierarchical tier t. In sufficiently high hierarchical tiers, the hierarchical tier evaluation values generally decrease monotonically with an increase in the hierarchical tier t. Although the hierarchical tier evaluation values randomly fluctuate in the short term, the moving average of the hierarchical tier evaluation values exhibits a monotonic increase or decrease. This property may be called “quasi-monotonicity”.

When the hierarchical tier evaluation values are arranged in ascending order of the hierarchical tier t, there is a peak in the hierarchical tier evaluation values, and the hierarchical tier evaluation values start to decrease after the peak. Therefore, the information processing apparatus 100 detects the peak in the hierarchical tier evaluation values and selects the hierarchical tier corresponding to the peak. Once the peak is detected, the information processing apparatus 100 need not calculate hierarchical tier evaluation values for hierarchical tiers higher than the peak because of the quasi-monotonicity property of the hierarchical tier evaluation values. In this manner, calculation of the hierarchical tier evaluation value is omitted for some hierarchical tiers.

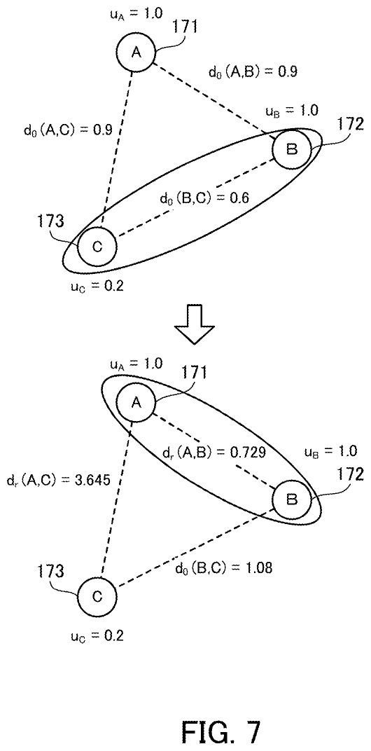

FIG. 7 illustrates an example of distance correction using model accuracies.

Now let us consider the case where the information processing apparatus 100 classifies two of sample programs 171, 172, and 173 into the same cluster based on the distances between the sample programs 171, 172, and 173. The Euclidean distance between the sample programs 171 and 172 is 0.9; the Euclidean distance between the sample programs 172 and 173 is 0.6; and the Euclidean distance between the sample programs 171 and 173 is 0.9. The model accuracy of the sample program 171 is 1.0; the model accuracy of the sample program 172 is 1.0; and the model accuracy of the sample program 173 is 0.2.

When hierarchical clustering is performed based only on the Euclidean distances, the information processing apparatus 100 classifies the sample programs 172 and 173 into the same cluster because the Euclidean distance between the sample programs 172 and 173 is the smallest. However, the model accuracies of the sample programs 172 and 173 are greatly different.

On the other hand, when using the aforementioned corrected distances, the information processing apparatus 100 calculates the corrected distance between the sample programs 171 and 172 as 0.729; the corrected distance between the sample programs 172 and 173 as 1.08; and the corrected distance between the sample programs 171 and 173 as 3.645. When performing hierarchical clustering based on the corrected distances, the information processing apparatus 100 classifies the sample programs 171 and 172 into the same cluster since the corrected distance between the sample programs 171 and 172 is the smallest.

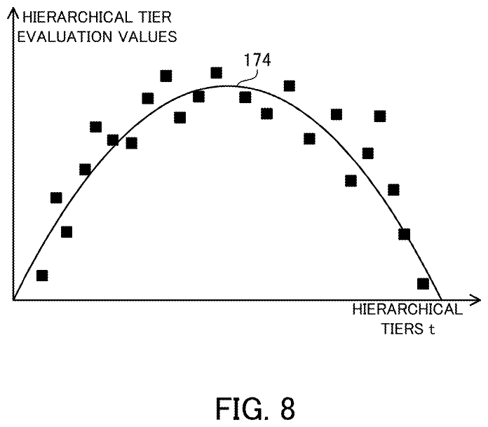

FIG. 8 is a graph illustrating a relationship example between hierarchical tiers and hierarchical tier evaluation values.

A curve 174 represents moving averages of hierarchical tier evaluation values with respect to the hierarchical tiers t. FIG. 8 plots the hierarchical tiers on the horizontal axis and the hierarchical tier evaluation values on the vertical axis. On the horizontal axis, the hierarchical tiers become lower toward the left and become higher toward the right. On the vertical axis, the hierarchical tier evaluation values become higher upwards along the axis.

The hierarchical tier evaluation values calculated by Equation (1) above do not have a strict monotonicity property for the hierarchical tiers. Note however that the hierarchical tier evaluation values have a quasi-monotonicity property that their moving averages monotonically increase in low hierarchical tiers and monotonically decrease in sufficiently high hierarchical tiers. The curve 174 has a peak with a maximum hierarchical tier evaluation value in an intermediate hierarchical tier.

The information processing apparatus 100 sequentially calculates the hierarchical tier evaluation value for each hierarchical tier in order from lower to higher hierarchical tiers in a dendrogram generated by the hierarchical clustering. The information processing apparatus 100 monitors the moving average of the hierarchical evaluation values and detects that the moving average has already exceeded the peak. Then, the information processing apparatus 100 selects, amongst hierarchical tiers for which the hierarchical tier evaluation value has been calculated, a hierarchical tier with the highest hierarchical tier evaluation value. Once the moving average has passed the peak, it is unlikely that hierarchical tier evaluation values higher than those already calculated would be obtained because of the quasi-monotonicity property. Therefore, the information processing apparatus 100 omits calculation of the hierarchical tier evaluation value for higher hierarchical tiers after the peak.

It is also said that, contrary to the above case, the hierarchical tier evaluation values have a quasi-monotonicity property that the moving average monotonically increases in high hierarchical tiers and monotonically decreases in sufficiently low hierarchical tiers. Therefore, the information processing apparatus 100 is able to detect the peak in the hierarchical tier evaluation values even in the mode of calculating the hierarchical tier evaluation values in order from higher to lower hierarchical tiers.

Regarding the monitoring of the moving average, for example, the information processing apparatus 100 calculates the average of the latest W hierarchical tier evaluation values as the moving average. W is the window width, which is above 5 to 7, for example. The information processing apparatus 100 compares the current moving average with the moving average of the immediately previous hierarchical tier to determine whether the current moving average has decreased. When the moving average decreases M times in succession, the information processing apparatus 100 determines that the moving average has already passed the peak. Note that M is, for example, about 3 to 5.

Note that the hierarchical tier evaluation value of a given hierarchical tier does not depend on the clustering results of other hierarchical tiers, and the information processing apparatus 100 is able to calculate the hierarchical tier evaluation values of multiple hierarchical tiers independently of each other. Therefore, the information processing apparatus 100 may separate the hierarchical clustering and the evaluation of the hierarchical tiers into different phases, or alternatively may integrally perform them.

In the former case, the information processing apparatus 100 first performs hierarchical clustering to the end to generate the entire tree dendrogram. Then, the information processing apparatus 100 sequentially calculates hierarchical tier evaluation values from lower to higher hierarchical tiers (or higher to lower hierarchical tiers) of the dendrogram until a peak is detected.

In the latter case, the information processing apparatus 100 advances the hierarchical clustering one hierarchical tier at a time in synchronization with the hierarchical tier evaluation. Once obtaining the clustering result of a given hierarchical tier, the information processing apparatus 100 calculates the hierarchical tier evaluation value of the hierarchical tier. The information processing apparatus 100 advances the hierarchical clustering to one hierarchical tier higher, and calculates the hierarchical tier evaluation value for the higher hierarchical tier. The information processing apparatus 100 repeats clustering of one hierarchical tier and evaluation of the one hierarchical tier until a peak is detected. This reduces the burden of hierarchical clustering. Note however that the following mainly describes an algorithm used in the former case.

Next described are functions and processing procedures of the information processing apparatus 100.

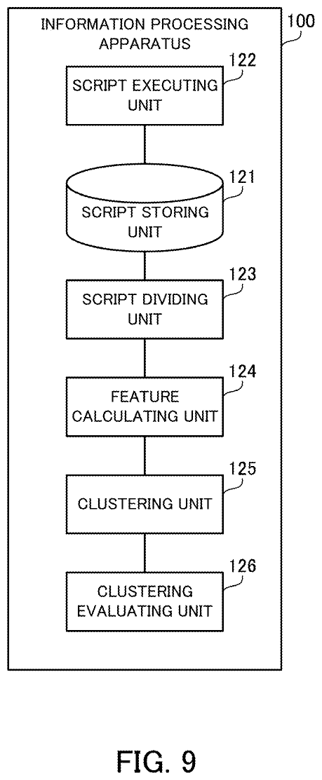

FIG. 9 is a block diagram illustrating an example of functions of an information processing apparatus.

The information processing apparatus 100 includes a script storing unit 121, a script executing unit 122, a script dividing unit 123, a feature calculating unit 124, a clustering unit 125, and a cluster evaluating unit 126. The script storing unit 121 is implemented using, for example, the RAM 102 or the HDD 103. The script executing unit 122, the script dividing unit 123, the feature calculating unit 124, the clustering unit 125, and the cluster evaluating unit 126 are implemented using, for example, the CPU 101 or the GPU 104 and programs.

The script storing unit 121 stores therein collected existing machine learning scripts. The script storing unit 121 also stores training data and test data for executing the machine learning scripts. Further, the script storing unit 121 stores model accuracies corresponding to the machine learning scripts. The model accuracies are measured by the script executing unit 122.

The script executing unit 122 executes the machine learning scripts stored in the script storing unit 121 using the training data and the test data. The GPU 104 may be used to execute the machine learning scripts. The script executing unit 122 stores, in the script storing unit 121, the model accuracies measured for the machine learning scripts.

Note that, if a machine learning script does not include code for measuring the model accuracy, the script executing unit 122 may measure the model accuracy of a trained machine learning model outside of the machine learning script. In addition, if the features of each sample program are calculated from memory states, the script executing unit 122 stores, in the script storing unit 121, a memory image for each step during execution of the machine learning script.

The script dividing unit 123 divides the machine learning scripts stored in the script storing unit 121 into multiple sample programs. For example, the script dividing unit 123 extracts n consecutive lines of code (n=1, 2, 3, and so on) included in a machine learning script as sample programs. A set of sample programs generated here may include sample programs extracted from different machine learning scripts. The script dividing unit 123 gives, to each sample program, the model accuracy of a corresponding original machine learning script.

The feature calculating unit 124 calculates features of each sample program extracted by the script dividing unit 123. For example, the feature calculating unit 124 extracts tokens from each sample program and calculates, as the features, a token vector which indicates the presence or absence of the tokens.

Based on the features calculated by the feature calculating unit 124 and the model accuracies measured by the script executing unit 122, the clustering unit 125 defines corrected distances between the sample programs according to Equation (2) above. Based on the corrected distances, the clustering unit 125 performs hierarchical clustering on the multiple sample programs extracted by the script dividing unit 123. Herewith, a dendrogram is generated that represents the clustering results of sample programs in each of multiple hierarchical tiers having different numbers of clusters.

According to the aforementioned Equation (1), the cluster evaluating unit 126 calculates the cluster evaluation value of each cluster from the results of the hierarchical clustering by the clustering unit 125 and the model accuracy given to each sample program. The cluster evaluating unit 126 calculates, for each of at least some of the hierarchical tiers, a hierarchical tier evaluation value obtained by adding together the cluster evaluation values of clusters included in the hierarchical tier. The cluster evaluating unit 126 calculates the moving average of the hierarchical tier evaluation values in ascending order of hierarchical tiers, detects a peak in the hierarchical tier evaluation values, and selects a hierarchical tier with the highest hierarchical tier evaluation value.

The cluster evaluating unit 126 may store the clustering result of the selected hierarchical tier in a non-volatile storage device; display them on the display device 111; and/or transmit them to different information processing apparatuses. The cluster evaluating unit 126 may also prompt the user to create software components from clusters included in the selected hierarchical tier. In addition, the cluster evaluating unit 126 may rank sample programs according to certain criteria for each cluster in the selected hierarchical tier, and present upper-ranked sample programs to the user as strong candidates for software componentization.

Alternatively, the cluster evaluating unit 126 may select, from each cluster, sample programs whose features are closest to the center of the cluster as strong candidates for software componentization. The cluster evaluating unit 126 may present to the user, amongst two or more clusters residing in the selected hierarchical tier, only clusters with cluster evaluation values exceeding a threshold or clusters with upper-ranked cluster evaluation values.

The information processing apparatus 100 may receive, from the user, software components edited based on the sample programs and store the received software components. Further, the information processing apparatus 100 may transmit the received software components to different information processing apparatuses.

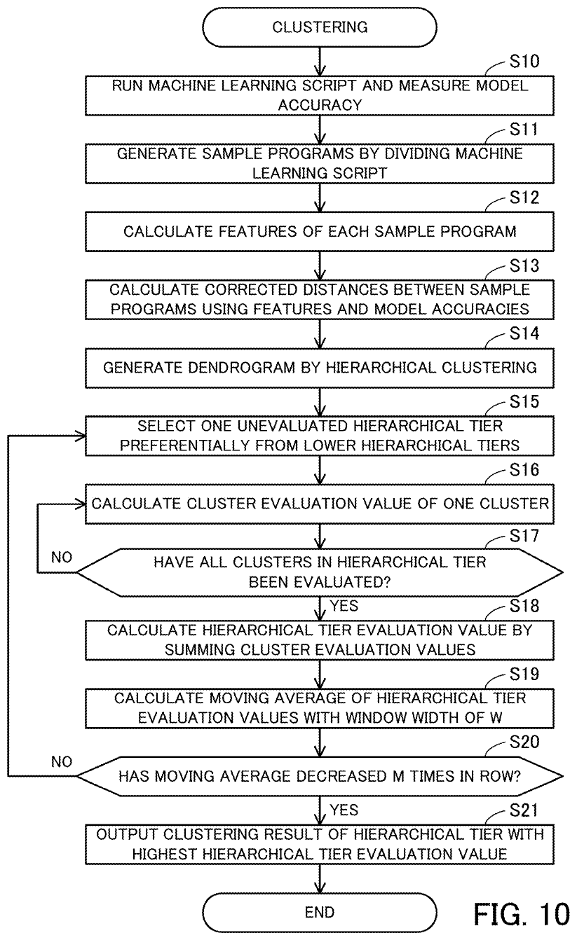

FIG. 10 is a flowchart illustrating an example of a clustering procedure.

(Step S10) The script executing unit 122 runs a machine learning script to measure the model accuracy of a machine learning model trained using the machine learning script.

(Step S11) The script dividing unit 123 divides the machine learning script to generate multiple sample programs, and gives the model accuracy to each of the sample programs.

(Step S12) The feature calculating unit 124 extracts tokens from the multiple sample programs and calculates, for each sample program, features indicating the presence or absence of the tokens.

(Step S13) The clustering unit 125 calculates, for each pair of sample programs, the Euclidean distance of the features calculated in step S12. The clustering unit 125 corrects each Euclidean distance using, amongst the model accuracies measured in step S10, a pair of model accuracies corresponding to the paired sample programs to obtain a corrected distance.

(Step S14) Using the corrected distances calculated in Step S13, the clustering unit 125 performs hierarchical clustering for classifying the multiple sample programs into clusters while decreasing the number of clusters in stages. Herewith, the clustering unit 125 generates a dendrogram representing the results of the hierarchical clustering.

(Step S15) The cluster evaluating unit 126 selects one unevaluated hierarchical tier, preferentially from the lower hierarchical tiers of the dendrogram generated in step S14.

(Step S16) The cluster evaluating unit 126 selects one cluster included in the hierarchical tier selected in step S15. The cluster evaluating unit 126 calculates the cluster evaluation value of the selected cluster. The cluster evaluation value is the product of the first term representing the cluster size, the second term representing the cohesion degree, the third term representing the mean of the model accuracies, and the fourth term representing the reciprocal of the variance of the model accuracies.

(Step S17) The cluster evaluating unit 126 determines whether all clusters included in the selected hierarchical tier have been evaluated. If all the clusters have been evaluated, the process moves to step S18. If there is one or more clusters that have yet to be evaluated, the process returns to step S16.

(Step S18) The cluster evaluating unit 126 sums the cluster evaluation values of all the clusters included in the selected hierarchical tier to calculate the hierarchical tier evaluation value of the selected hierarchical tier.

(Step S19) If the hierarchical tier evaluation values of W or more hierarchical tiers have already been calculated, the cluster evaluating unit 126 calculates a moving average of the hierarchical tier evaluation values with a window width of W.

(Step S20) The cluster evaluating unit 126 compares the moving average calculated for the previous hierarchical tier with the moving average calculated for the current hierarchical tier. The cluster evaluating unit 126 determines whether the hierarchical tier evaluation values for W or more hierarchical tiers have already been calculated, whether the moving average of the hierarchical tier evaluation values has already been calculated M+1 times, and whether a peak condition is satisfied that the moving average has decreased M times in a row.

If the peak condition is satisfied, the process moves to step S21. If the peak condition is not satisfied, the process returns to step S15. When the peak condition is not met, the following three cases are considered: the hierarchical tier evaluation values for less than W hierarchical tiers have been calculated; the moving average has been calculated M times or less; and the moving average has yet to fall M times in a row.

(Step S21) The cluster evaluating unit 126 selects a hierarchical tier with the highest hierarchical tier evaluation value from the dendrogram. The cluster evaluating unit 126 outputs the clustering result of the selected hierarchical tier.

As has been described above, the information processing apparatus 100 of the second embodiment extracts a set of sample programs from existing machine learning scripts, and divides the set of sample programs into two or more clusters by hierarchical clustering. Herewith, clusters suitable to be made into individual single software components are presented to the user, thus streamlining the work of creating software components related to machine learning scripts.

The information processing apparatus 100 also calculates a cluster evaluation value for each cluster, and calculates, for each of multiple hierarchical tiers having different numbers of clusters, a hierarchical tier evaluation value using the cluster evaluation values. Then, the information processing apparatus 100 selects, amongst the clustering results of the multiple hierarchical tiers, the clustering result of a hierarchical tier with the highest hierarchical tier evaluation value. This eliminates the need for manually determining an appropriate hierarchical tier from the multiple hierarchical tiers, and streamlines the work of creating software components. In particular, when a dendrogram with deep hierarchical tiers is generated from a large number of sample programs, a hierarchical tier suitable for componentization is automatically determined.

In addition, the information processing apparatus 100 calculates, as a cluster evaluation value for each cluster, the product of the first term representing the cluster size, the second term representing the cohesion degree of intra-cluster features, the third term representing the mean of model accuracies within the cluster, and the fourth term representing the reciprocal of the variance of the model accuracies within the cluster. Herewith, clusters are evaluated from the view point of reusability and utility of software components, which allows for creating high-quality software components from clusters with high cluster evaluation values.

The information processing apparatus 100 also corrects the Euclidean distance between two sample programs in terms of their features by using the model accuracies of the two sample programs. Each corrected distance is inversely proportional to the model accuracies of the two sample programs. This allows the hierarchical tier evaluation values to have a quasi-monotonicity property that they do not randomly fluctuate with changing hierarchical tiers, and a peak is found in the hierarchical tier evaluation values. Therefore, the information processing apparatus 100 is able to estimate a hierarchical tier with the highest hierarchical tier evaluation value without calculating the hierarchical tier evaluation value for all the hierarchical tiers, thus reducing the load on the information processing apparatus 100.

In the hierarchical clustering using the corrected distances, each pair of sample programs both having high model accuracies, with a small Euclidean distance of the features, is preferentially classified into the same cluster. In lower hierarchical tiers, clusters grow around such sample programs by incorporating surrounding sample programs having relatively small Euclidean distances of the features and relatively high model accuracies. As a result, clusters suitable for creating software components are likely to be generated.

The information processing apparatus 100 is able to alternately perform evaluation of a hierarchical tier and clustering of the next higher hierarchical tier, instead of performing hierarchical clustering all at once. This further reduces the load on the information processing apparatus 100.

According to one aspect, it is possible to streamline creation of software components from sample programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring a plurality of clustering results, each of which differs in a number of clusters, by performing clustering that classifies a plurality of sample programs into two or more clusters based on features associated with description of each of the plurality of sample programs and an execution performance of each of the plurality of sample programs;
calculating, for each cluster of the two or more clusters in each of the plurality of clustering results, a first evaluation value based on an index value for reusability of two or more sample programs included in the each cluster and the execution performances of the two or more sample programs;
calculating, for each of the plurality of clustering results, a second evaluation value based on two or more of the first evaluation values corresponding to the two or more clusters; and
selecting, based on a plurality of second evaluation values respectively corresponding to the plurality of clustering results, one clustering result amongst the plurality of clustering results.

2. The non-transitory computer-readable recording medium according to claim 1, wherein the clustering includes correcting a distance between different sample programs in terms of the features by using the execution performance of each of the different sample programs, and classifying the plurality of sample programs based on the corrected distance.

3. The non-transitory computer-readable recording medium according to claim 2, wherein the corrected distance is inversely proportional to the execution performances.

4. The non-transitory computer-readable recording medium according to claim 1, wherein the selecting includes skipping the calculating of the second evaluation value for other clustering results than the plurality of clustering results amongst a plurality of pattern candidates, each of which differs in the number of clusters, based on a relationship between the number of clusters and the second evaluation values.

5. The non-transitory computer-readable recording medium according to claim 4, wherein:
the second evaluation values are calculated in descending or ascending order of the number of clusters, and
the selecting includes detecting a peak in the second evaluation values and skipping, upon the detecting of the peak, the calculating of the second evaluation value for the other clustering results that follow the peak in the descending or ascending order.

6. The non-transitory computer-readable recording medium according to claim 1, wherein:
the clustering is hierarchical clustering that generates a tree structure including a plurality of hierarchical tiers, and
the selecting includes selecting one hierarchical tier amongst the plurality of hierarchical tiers.

7. The non-transitory computer-readable recording medium according to claim 1, wherein the calculating of the first evaluation value includes calculating, for each cluster of the two or more clusters, the first evaluation value based on a number of sample programs included in the each cluster, a cohesion degree corresponding to variance of the features of the two or more sample programs included in the each cluster, a mean of the execution performances, and variance of the execution performances.

8. An information processing method, executed by a computer, the information processing method comprising:
acquiring, by a processor, a plurality of clustering results, each of which differs in a number of clusters, by performing clustering that classifies a plurality of sample programs into two or more clusters based on features associated with description of each of the plurality of sample programs and an execution performance of each of the plurality of sample programs;
calculating, by the processor, for each cluster of the two or more clusters in each of the plurality of clustering results, a first evaluation value based on an index value for reusability of two or more sample programs included in the each cluster and the execution performances of the two or more sample programs;
calculating, by the processor, for each of the plurality of clustering results, a second evaluation value based on two or more of the first evaluation values corresponding to the two or more clusters; and
selecting, by the processor, based on a plurality of second evaluation values respectively corresponding to the plurality of clustering results, one clustering result amongst the plurality of clustering results.

9. An information processing apparatus comprising:
a memory configured to store a plurality of sample programs and an execution performance of each of the plurality of sample programs; and
a processor coupled to the memory and the processor configured to:
acquire a plurality of clustering results, each of which differs in a number of clusters, by performing clustering that classifies the plurality of sample programs into two or more clusters based on features associated with description of each of the plurality of sample programs and the execution performances;
calculate, for each cluster of the two or more clusters in each of the plurality of clustering results, a first evaluation value based on an index value for reusability of two or more sample programs included in the each cluster and the execution performances of the two or more sample programs;
calculate, for each of the plurality of clustering results, a second evaluation value based on two or more of the first evaluation values corresponding to the two or more clusters; and
select, based on a plurality of second evaluation values respectively corresponding to the plurality of clustering results, one clustering result amongst the plurality of clustering results.
